(19) United States
(12) Patent Application Publication
(10) Pub. No.: US 2021/0129430 A1
(43) Pub. Date: May 6, 2021

(54) ADDITIVE MANUFACTURING

(71) Applicant: Hewlett-Packard Development Company, L.P., Spring, TX (US)

(72) Inventors: Alex Veis, Netanya (IL); Esteve Comas Cespedes, Sant Cugat del Valles (ES); Marc Jansa Perez, Sant Cugat del Valles (ES); Xavier Soler Pedemonte, Sant Cugat del Valles (ES)

(21) Appl. No.: 17/051,958

(22) PCT Filed: Oct. 17, 2018
(86) PCT No.: PCT/US2018/056259

§ 371 Date: Oct. 30, 2020

(51) Int. Cl. B29C 64/165; B29C 64/277; B22F 10/14; B33Y 10/00; B33Y 30/00

(52) U.S. Cl. CPC B29C 64/165; B29C 64/277; B33Y 30/00; B33Y 10/00; B22F 10/14

(57) ABSTRACT

According to one example, there is provided a method of additive manufacturing that comprises obtaining data relating to a 3D object to be manufactured, forming a layer of build material on a build platform, applying a cooling agent in a pattern surrounding a portion of build material to be solidified, and applying energy only to the build material on which cooling agent is applied and to the surrounded portion of build material such that the surrounded portion of build material heats up sufficiently to coalesces, and such that build material on which cooling agent is applied is cooled by the cooling agent and is prevented from heating up sufficiently to coalesce.

### BACKGROUND

Some additive manufacturing, or three-dimensional (3D) printing, processes selectively solidify portions of successive layers of a powdered or particulate build material using heat. Some processes directly apply heat in a point-to-point manner to portions of each layer that are to be solidified, for example using a laser. Other processes apply an energy absorbing fusing agent to portions of each layer that are to be solidified and then apply energy generally to the whole of each layer to cause solidification of those portions on which fusing agent was applied. Point-to-point energy processes may be more energy efficient than whole layer energy processes since energy is only applied to those portions to be solidified. However, point-to-point energy processes may be much slower than whole layer energy processes since such an energy source can only apply energy to one point of a build material layer at a time.

### BRIEF DESCRIPTION

Examples will now be described, by way of non-limiting example only, with reference to the accompanying drawings, in which:

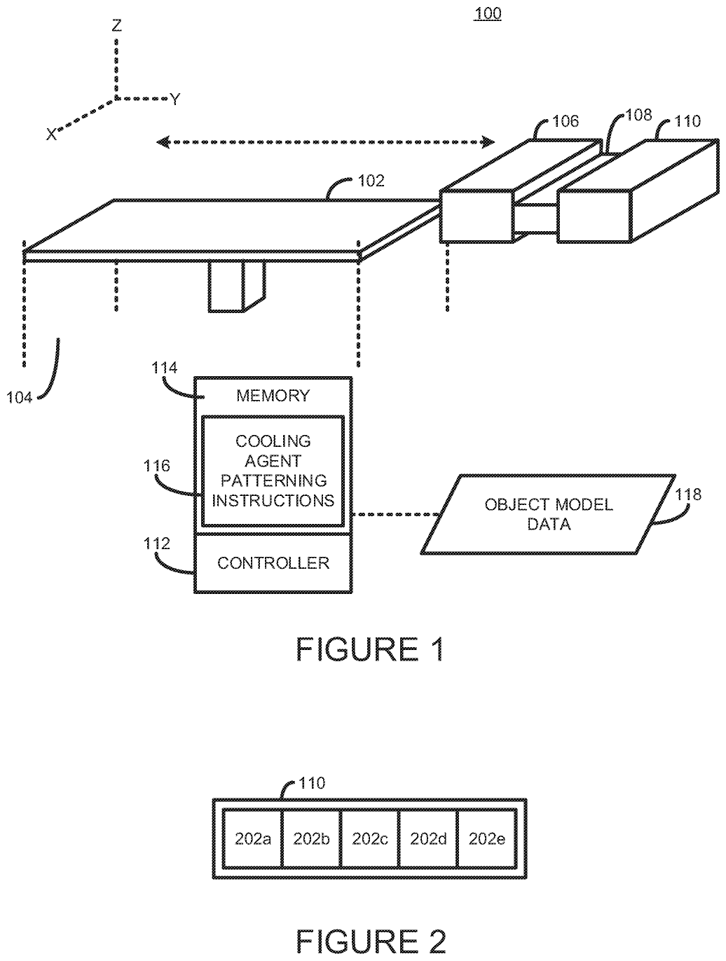

FIG. 1 is a schematic diagram showing a 3D printing system according to one example;

FIG. 2 is a schematic diagram showing an energy source according to one example;

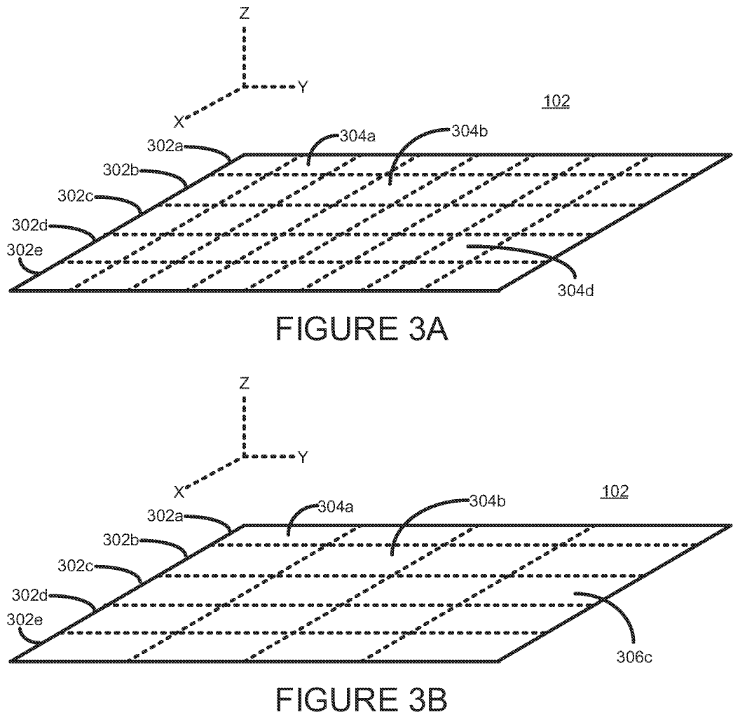

FIG. 3A is an illustration of a build platform or build material layer divided up into a number of heating bands, according to one example;

FIG. 3B is an illustration of a build platform or build material layer divided up into a number of heating bands, according to one example;

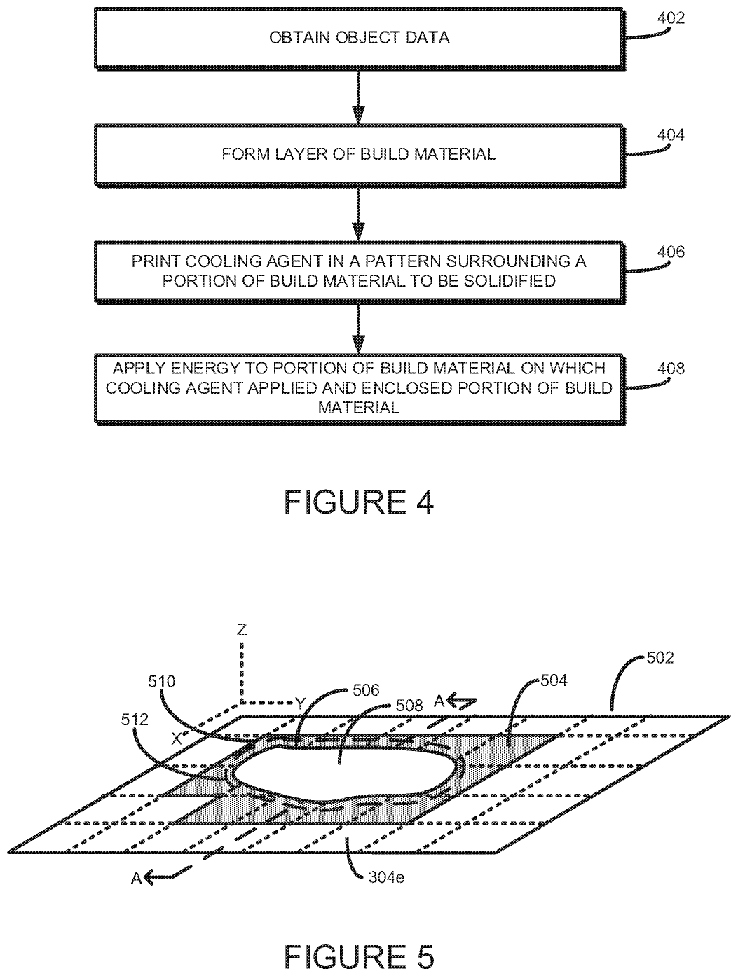

FIG. 4 is a flow diagram illustrating an example method of operating a 3D printing system according to one example;

FIG. 5 is an isometric illustration of a layer of build material on which a pattern of cooling agent has been applied, according to one example;

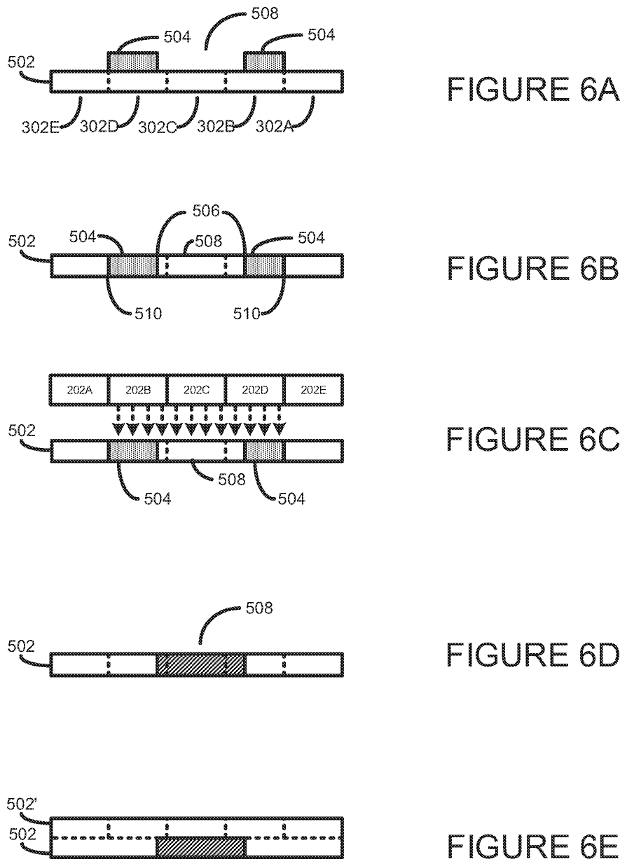

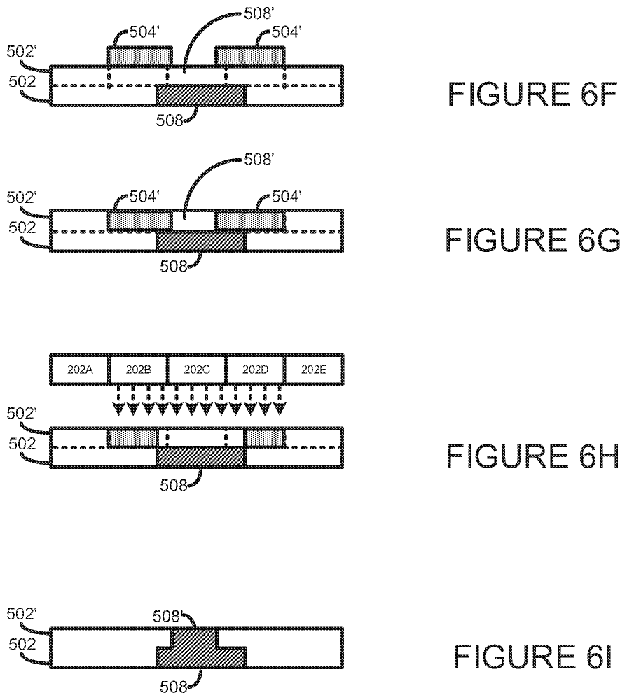

FIGS. 6A to 6I are schematic illustrations of a portion of build material undergoing various processes according to one example;

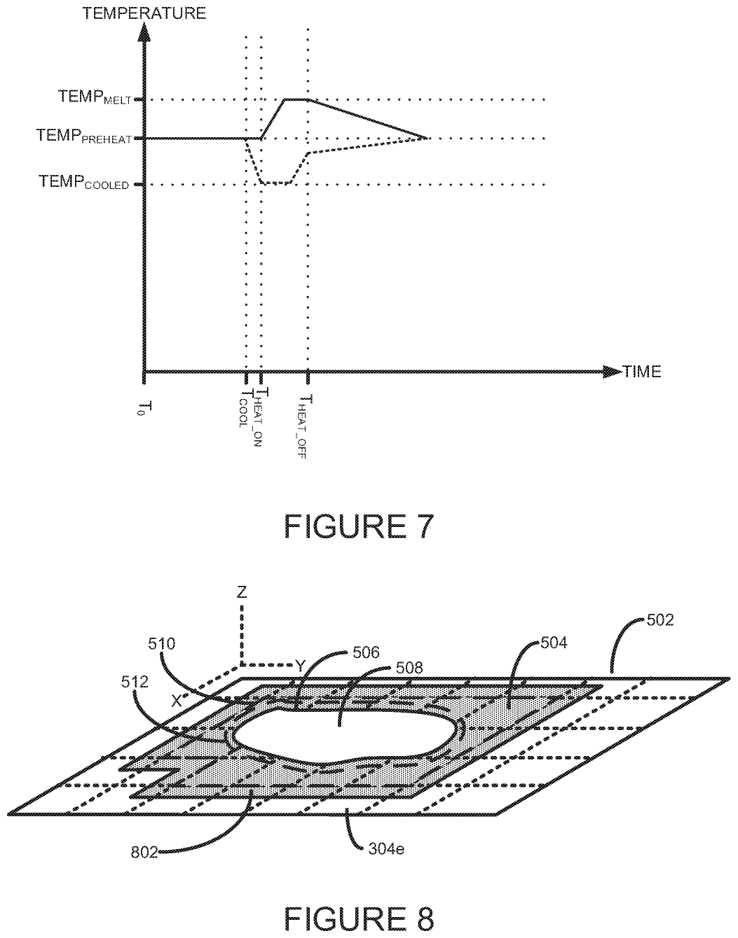

FIG. 7 is a graph showing how the temperature of a portion of build material changes over time during an example 3D printing process;

FIG. 8 is an isometric illustration of a layer of build material on which a pattern of cooling agent has been applied, according to one example; and

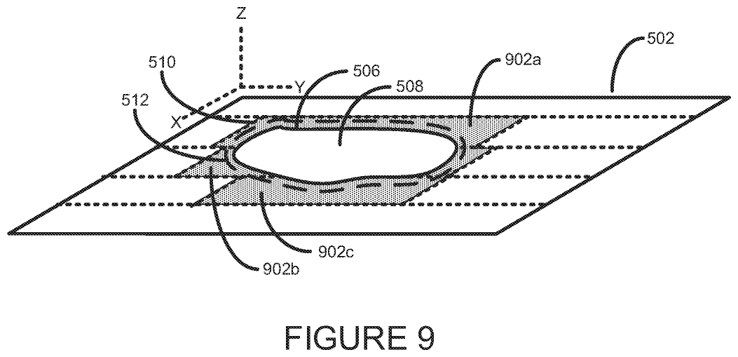

FIG. 9 is an isometric illustration of a layer of build material on which a pattern of cooling agent has been applied, according to one example.

### DETAILED DESCRIPTION

The present disclosure describes examples of a fast and energy efficient 3D printing system and process that enables high-quality 3d objects to be generated. The example printing system and processes described herein do not result in contamination of non-solidified build material with anti-sintering or other agents that leave significant residual elements, thereby allowing all, or almost all, of the non-solidified build material to be recovered and be reused to generated 3D objects in subsequent 3D printing operations.

As described in further detail below, the present disclosure describes a 3D printing process that utilizes a liquid cooling agent to define a boundary region on a layer of build material that encloses a portion of a layer of build material that is to be solidified. Energy is applied only to the portion of the layer of build material on which cooling agent is applied and to the enclosed portion of build material (on which no cooling agent is applied). The energy causes the enclosed portion of build material on which no cooling agent was applied to heat up such that it melts, fuses, sinters, or otherwise coalesces, prior to solidifying upon cooling. The build material on which cooling agent is applied is prevented from reaching a high-enough temperature to melt, fuse, sinter, or otherwise coalesce, and this irrespective of whether the energy on the portion is received directly from an energy source, or due to thermal conduction from adjacent regions of build material that do heat up sufficiently to melt, fuse, sinter, or otherwise coalesce. Furthermore, in one example the cooling agent is comprised predominantly from water, such that it substantially evaporates leaving no, or substantially no, contaminants on the build material. This enables such build material to be recovered after a 3D printed object has been generated and reused in subsequent 3D printing operations.

Furthermore, as fusing energy is not applied to other portions of build material which are not to be solidified, this makes the process particularly energy efficient. Additionally, this prevents such portions from degrading or prematurely aging, and also prevents so-called ‘caking’ of non-solidified build. ‘Caking’ is a phenomenon where non-solidified build material may become sticky when heated which may cause it to stick to portions of solidified build material and may also cause it to become non-free flowing. Caking makes separation of generated 3D objects from non-solidified build material difficult.

The term ‘fusing energy’ is used herein to refer to energy that is applied to sufficiently heating up a portion of build material on which no cooling agent is applied to cause it to melt, fuse, sinter, or otherwise coalesce, (referred to generally herein as ‘melting temperature’) prior to solidifying upon cooling. The term ‘preheating energy’ is used herein to refer to energy that is applied to heat up a portion of build material on which no cooling agent is applied to cause it to heat to a predetermined temperature below the melting (or as appropriate, fusing, sintering, or crystallization) temperature of the build material. In one example, preheating may be used to heat build material to within a temperature of about 10 degrees Celsius, or about 20 degrees Celsius, or about 30 degrees Celsius, or about 40 degrees Celsius, or about 50 degrees Celsius of the melting temperature of the build material. In other examples preheating may be used to heat build material to a different temperature range below the melting temperature.

Referring now to FIG. 1, there is shown a 3D printing system 100 according to one example. The 3D printing system 100 comprises, in use, a build platform 102 on which successive layers of a powder or particulate type build material may be formed. The build material may, in one example, be a suitable plastic build material, such as PA12, PA11, TPU, or any other suitable plastic build material. In other examples the build material may be any suitable metal or ceramic build material.

The build platform 102 is part of a build chamber 104, illustrated for clarity in dotted lines, in which 3D printed objects may be generated. The build chamber may, for example, be a generally open cuboid structure in which the build platform 102 forms a vertically movable base. In one example, the build chamber is part of a removable build unit (not shown) that may be removed from the 3D printing system after a 3D print job has been performed. In another example, the build chamber is integrated into the 3D printing system 100.

Successive layers of build material may be formed on the build platform 102 using a suitable mechanism. In the example shown a recoater 106, such as a roller or wiper, is mounted on a carriage (not shown) that is translatable over the build platform 102 to spread a volume of build material provided by a suitable build material deposition system (not shown). A volume of build material to be spread over the build platform 102 may be provided by a suitable build material dosing module (not shown) and deposited, for example, on a support platform adjacent to the build chamber.

An initial layer of build material may be formed directly on the build platform 102, whereas subsequent layers may be formed on a previously formed layer. The build platform 102 may be initially positioned such that the top surface of the build platform 102, or the top layer of the uppermost layer of build material formed therein, is a predetermined distance below the lower surface of the recoater 106 to enable build material layers of a predetermined height, or thickness, to be formed. In one example, each layer may have a predetermined height in the range of about 50 to 120 microns, although in other examples a larger or smaller height may be chosen. In one example, each layer of build material is formed to have a generally uniform thickness. In one example, each of the layers has substantially the same general thickness. The build platform 102 may be lowered by a suitable amount to allow each layer of build material to be formed thereon at the desired thickness.

In one example, the build material layer may be preheated to a predetermined temperature below the melting temperature of the build material. For example, preheating energy may be applied to each formed build material layer by a preheating energy source (not shown) such as a halogen lamp, an array of light emitting diodes, an array of lasers, or the like. In another example, the build material may be preheated in a suitable manner prior to it being formed into a layer of build material.

The 3D printing system 100 further comprises a cooling agent delivery module 108 for selectively delivering drops of a liquid cooling agent to addressable locations on each formed layer of build material. In one example the agent deliver mechanism 108 is a printhead, such as a thermal or piezo inkjet type printhead. Such a printhead may have an array of nozzles, or be arranged as an array of printheads each having an array of nozzles, that span the width (or x-axis) of the build platform 102. In one example, the printhead may have 1200 nozzles per inch along the x-axis of the printhead, thereby allowing cooling agent to be selectively delivered to locations of each layer of build material at an x-axis resolution of about 20 microns. In one example the agent delivery mechanism 108 may be mounted on the same carriage as the recoater 106, although in another example it may be mounted on a separate carriage (not shown). By controlling the speed of the carriage and the frequency at which drops of cooling fluid are ejected, or fired, from the agent delivery mechanism, the addressable resolution of the agent delivery mechanism in the y-axis may be selected to also be about 20 microns. In other examples, however, the y-axis resolution of the agent delivery mechanism may be selected to be higher or lower. In one example, the cooling liquid may be applied from a printhead nozzle in drop sizes from about 2 pl to 100 pl, depending on the type of printhead used.

The cooling agent may be stored in a suitable fluid container (not shown) that is fluidically coupled to the cooling agent delivery system 106. Details of the cooling agent are given further below.

The cooling agent may be any suitable liquid agent that, when applied to a portion of a layer of build material has a cooling effect, i.e. a temperature reducing or modulation effect, on at least part of the portion of build material on which it is applied. In one example the cooling agent may penetrate at least partially into a portion of build material to which it is applied and consequently may provide a cooling effect to individual build material particles.

In one example, the cooling effect of the cooling agent may be immediate, or quasi-immediate, for example if the temperature of the cooling agent when applied is below the temperature of the portion of build material. For example, if the build material is preheated to 120 degrees Celsius, and the cooling agent is at a temperature of 40 degrees Celsius, the cooling agent will reduce the temperature of the build material to which it is applied.

In another example, the cooling effect of the cooling agent may occur, at least partially, at a time subsequent to its application. For example, if the cooling agent has a temperature close to the temperature of the build material, the cooling effect may be a relative cooling effect that occurs when fusing energy is applied to a portion of build material on which cooling agent is present and to a portion of build material on which cooling agent is not present. For example, if the cooling agent is a substantially water-based liquid, upon application of fusing energy the cooling agent may evaporate, and thus prevent the build material on which it is applied from reaching the melting temperature of the build material, whereas build material on which no cooling is applied will reach its melting temperature. Furthermore, should a portion of build material on which no cooling agent is applied be heated by fusing energy to reach its melting temperature, heat from that portion which radiates, conducts, or otherwise migrates to, or bleeds into, an adjacent portion of build material on which cooling agent is applied will be attenuated by the cooling agent, thereby preventing the adjacent portion of build material on which cooling agent is applied from heating up to the build material melting temperature.

In one example the cooling agent is a water-based liquid comprising at least 50% of water, or at least 60% of water, or at least 70% of water, or at least 80% of water, or at least 90% of water, or at least 95% of water, or at least 99% of water. Such a cooling agent composition enables the majority of the cooling agent to be evaporated when sufficient fusing agent is applied to build material on which cooling agent has been applied, leaving no or minimal residual components. In this way, build material on which cooling agent is applied is not contaminated in any significant manner, enabling build material on which cooling agent has been applied to be reused in subsequent 3D printing operations.

The 3D printing system 100 further comprises a translatable energy source 110 for selectively applying fusing energy along a heating band having a width that spans the x-axis of the build platform 102. In one example the energy source 110 may be mounted on the same carriage as the recoater 106 or the agent delivery module 108, although in another example it may be mounted on a separate carriage (not shown). As illustrated in the bottom view shown in FIG. 2, the energy source 110 comprises an array of individually controllable energy elements 202, such as light emitting diodes (LEDs), laser diodes, halogen lamps, or the like. Each of the energy elements 202 may be individually controlled to apply an amount of energy in response to an appropriate control signal. Each of the energy elements 202 is configured to provide energy to a discrete portion, or band, of a layer of build material such that each discrete portion or band receives energy substantially only from a single energy element. For example, each energy element may comprise an optical lens, a reflector, or any other suitable energy directing component. In this way, the energy source 202 may be used to substantially uniformly apply energy to any discrete band or portion of a layer of build material, as illustrated in FIGS. 3A and 3B.

FIG. 3A shows the build platform 102 (or a layer of build material formed on the build platform 102) divided up into a number of heating bands 302a to 302e that extend along the y-axis. Each of the heating bands 302a to 302e correspond to bands of the build platform 102 that may receive energy from a corresponding energy element 202a to 202e of the energy source 110 as the energy elements 202 are scanned over the build platform 102. In the example shown, each of the energy elements 202 may be individually controlled, for example switched on and off, as the energy source 110 is scanned over the build platform 102.

In one example, each of the energy elements 202 may be individually controlled at a fixed frequency, thereby defining a number of discrete heating cells 304 that may selectively receive energy from a corresponding energy element 202. In the example shown, based on the speed at which the energy source 110 is moved over the build platform 102 and the frequency at which each energy element 202 is controlled, each heating band is divided into 8 discrete heating cells. The size of each of these heating cells may be modified, as illustrated in FIG. 3B, for example by modifying one of the speed of the energy source 110, and the frequency at which each of the energy elements 202 are controlled.

In the example shown in FIG. 3 each of the heating cells 304 are shown aligned along the y-axis, in other examples the heating cells 304 for each band may be out of alignment with heating cells of other bands along the y-axis.

The energy source 110 is to provide fusing energy, for example infra-red energy or ultra-violet energy, to cause, as the energy source 110 is moved over the build platform 102, build material on which the energy is applied to heats up sufficiently to melt, fuse, sinter, or otherwise coalesce, and then to solidify upon cooling. In one example, where a PA12 build material is used, the energy source may heat up build material to a temperature of about 160 degrees Celsius. In one example, each layer of build material formed on the build platform 102 may be preheated to a temperature below (for example, 20 degrees Celsius below) the melting point of the build material. In one example such a preheating phase may be performed by an overhead pre-heating energy source (not shown), or by a suitable scanning pre-heating energy source (not shown). In one example the pre-heating may be performed by the energy source 110, for example controlled to emit a reduced amount of energy compared to when used to emit fusing energy.

In one example, the build material to be used by the 3D printing system 100 is a good absorber of energy emitted by the energy source 110. For example, the build material may be selected such that its peak energy absorptance is closely matched to the peak emission spectrum of the energy source 110. In one example, the build material may be a generally dark colour, such as black, dark grey, dark red, or the like. In another example, the build material be of any other colour, and the energy source may be chosen to have a peak emission spectrum closely matching the peak absorbance spectrum of the build material. For example, the energy source 110 may comprise an array of ultra-violet (UV) LEDs that emit electromagnetic energy in about the 300 nm to 410 nm range. Such LEDs may be suitable for applying fusing energy to build materials having a colour in a wide gamut of colours. Suitable build materials may have an energy absorption of greater than 50% in such an energy spectrum.

In one example, the cooling agent is a transparent or substantially transparent liquid. In another example, the cooling agent is a coloured liquid that has a colour that closely matches, or is substantially the same as, the colour of the build material. For example, if the build material has a light blue colour, the cooling agent may be one of: a transparent or substantially transparent liquid; and a similar light blue colored liquid. A colour match, or a degree of closeness, may, for example, be evaluated in colourimetric terms by means of colour difference metrics, such as those defined by CIE (International Commission on Illumination) DE 2000 or in other suitable colour metrics.

In one example the cooling agent may comprise a dye or a colourant The operation of the 3D printing system 100 is controlled generally by a 3D printer controller 112. The controller 112 may comprise, for example, a microprocessor, a microcontroller, a computer, or the like. The controller 112 is coupled to a memory 114, for example through a suitable communications bus (not shown). Machine-readable cooling agent patterning instructions 116 are stored in the memory 114. When executed by the controller 112, the instructions 116 cause the processor to control various actions of the 3D printer 100 as described herein, for example with reference to the flow diagram of FIG. 4. Further reference is made to FIG. 5, which is an isometric illustration of a layer of build material 502 on which a pattern of cooling agent 504 has been applied. Yet further reference is made to FIGS. 6A to 6I, which represent cross-sections of the build material layer along the line A:A of FIG. 5 at different times during the generation of a 3D object.

At block 402, the controller 312 may obtain object model data 318 that defines, or is derived from, a 3D object model of a 3D object that is to be generated by the 3D printer 100. In one example the object model data is an object model stored in a vector graphics, in a voxel format, or in another other suitable format. In another example the object model data may be sliced data defining a two-dimensional bitmap image representing one or more slices taken through a 3D object model corresponding to a layer of a 3D object to be generated. The object data enables the controller 312 to determine, for each layer of build material to be processed by the 3D printing system 100, which portions of each layer should be solidified to form a layer of the 3D object being generated.

At block 404, the controller 312 controls the recoater 106 to form a layer of build material on the build platform 102.

At block 406, the controller 312 controls the cooling agent delivery module 108 to deliver cooling agent in a pattern 504 based on the obtained data.

The controller 312 defines the pattern of cooling agent 504 to have an inner boundary 506 that encloses, or surrounds, a portion 508 of build material which corresponds to the portion of the build material layer 502 which is to be solidified, based on the obtained data, to form a layer of the 3D object being generated. The inner boundary 506 thus defines the cross-section of a layer of the 3D object being generated.

The cooling agent applied around the enclosed portion 508 is applied in a pattern having at least a predetermined minimum width, to provide a suitable cooling barrier, as shown by the cooling boundary 512. In one example the cooling boundary 512 is a boundary of least 1 mm, or at least 2 mm, or at least 5 mm, or at least 20 mm, or at least 50 mm. The controller 312 defines the pattern of cooling agent 504 to have an outer boundary 510 that is aligned with the outer boundary of each of the heating cells 304 in which the cooling boundary 512 of the cooling agent pattern is present. In this way, the actual width of the cooling boundary may, in some locations, be somewhat greater than the predetermined minimum width.

At block 408, fusing energy may then be applied only to the regions in which either cooling agent has been applied and to a region surrounded by cooling agent which is intended to be solidified to cause build material on which no cooling agent was applied to heat up sufficiently to melt, fuse, sinter, or otherwise coalesce, and then to solidify upon cooling, whereas build material on which cooling agent was applied does not heat up sufficiently and hence does not solidify. Build material outside of the region 504 on which no cooling agent was applied does not have energy applied thereto, and hence does not heat up significantly and does not solidify. In one example, the quantity of cooling agent applied is such that after application of fusing energy all, or substantially all, of the cooling agent evaporates.

An example of the 3D printing process is described in more detail with reference to FIGS. 6A to 6I, which represent a portion of a layer of build material along the section A:A shown in FIG. 5. It will be understood that drawings in FIGS. 6A to 6I are schematic in nature to assist understanding of the principles described herein.

As shown in FIG. 6A, a layer of build material 502 has been formed by recoater 106, and a pattern of cooling agent 504 is applied on the build material layer by the cooling agent delivery module 108. The pattern of cooling agent 504 may be formed, for example, from a set of one or more droplets of cooling agent. For example, where the cooling agent distribution module 108 is a printhead, each drop of cooling agent may be ejected by a different printhead nozzle. For reference, each of the heating bands 302A to 302E are shown, with the boundary between each neighbouring band shown in dotted line.

As shown schematically for simplicity in FIG. 6B, the cooling agent drops are substantially absorbed into the layer of build material where it was applied. However, depending on characteristics of the cooling agent, and/or characteristics of the build material, a portion of the cooling agent may remain, at least temporarily, on the surface of the build material. It can be seen that the inner boundary 506 of the pattern of cooling agent 504 defines the portion 508 of build material to be solidified. It can also be seen that the outer boundary 510 of the pattern of cooling agent is aligned with a boundary of a respective one of the bands. For example, the leftmost outer boundary 510 is aligned with the boundary between the band 302E and the band 302D, and the rightmost outer boundary 510 is aligned with the boundary between the band 302A and the band 302B.

FIG. 6C shows the application of energy, represented by the arrows, to portions of the layer of build material 502 by energy source 110. As shown, energy elements 202B, 202C, and 202D are controlled to emit energy, whereas energy elements 202A and 202E are not controlled to emit energy. In this way, energy is applied only to the portion of build material 508 which is intended to be solidified and portions of build material 504 on which cooling agent was applied.

As shown in FIG. 6D, after application of energy, the portion of build material 508 has, upon cooling, solidified, and the cooling agent has completely, or substantially, evaporated from portions of build material on which it was applied. The solidified portion of build material 508 corresponds to a layer of a 3D object being generated.

As shown in FIG. 6F, a further layer of build material 502′ is formed atop the previously formed and processed build material layer 502. A further pattern of cooling agent 504′ is applied to the newly form layer of build material 502′.

As shown in FIG. 6G, the cooling agent drop are substantially absorbed into the layer of build material where it was applied. It can be seen that the pattern of cooling agent 504′ defines the portion 508′ of build material to be solidified. It can also be seen that the outer boundary of the pattern of cooling agent is aligned with a boundary of a respective one of the bands.

FIG. 6H shows the application of energy, represented by the arrows, to portions of the layer of build material 502′ by energy source 110. As shown, energy elements 202B, 202C, and 202D are controlled to emit energy at this location, whereas energy elements 202A and 202E are not controlled to emit energy. In this way, energy is applied only to the portion 508 of build material layer 502′ which is intended to be solidified and portions of build material 504′ on which cooling agent was applied.

As shown in FIG. 6I, after application of fusing energy, the portion of build material 508′ has, upon cooling, solidified, and the cooling agent has completely, or substantially, evaporated from portions of build material on which it was applied. In another example, however, the quantity of cooling agent applied may be increased such that after application of fusing energy a portion of cooling agent remains. This may be useful, for example, to prevent thermal bleed from subsequently processed layers of build material. The portion 508′ represents a further layer of the 3D object to be generated. Furthermore, due to the small thickness of each layer of build material, the solidified portion 508′ at least partially fuses with the solidified portion 508, thereby forming a substantially homogenous volume of solidified build material.

The process may then be repeated until all of the layers of a 3D object have been generated.

FIG. 7 is a graph showing how the temperature of a portion of build material changes over time during the above-described process, depending on whether the build material receives no cooling, shown in the upper solid line, or whether the build material receives cooling agent, shown in the lower dashed line.

At time T₀ the build material is preheated to a predetermined temperature TEMP_{PREHEAT}.

At time T_{COOL} the cooling agent delivery module 108 applies a quantity of cooling agent onto a portion of build material that surrounds a portion of build material that is to be solidified. Since the temperature of the cooling agent is lower than the temperature of the build material, the temperature of the build material to which the cooling agent is applied drops to TEMP_{COOLED}.

At time T_{HEAT_ON}, and until time T_{HEAT_OFF}, fusing energy is applied to the portion of build material on which cooling agent was applied, as well as to the portion of build material surrounded thereby which is to be solidified. The build material on which cooling agent was applied remains initially stable, as the cooling agent evaporates. The evaporation of the cooling agent prevents the temperature of the build material to which is was applied from rising. However, towards the end of the fusing energy period the temperature of the build material on which cooling agent was applied may rise. The build material on which no cooling agent was applied, however, sees its temperature rise up to the temperature TEMP_{MELT} and it may remain at temperature TEMP_{MELT} until the fusing energy is no longer applied. This causes the build material to melt, sinter, fuse, or otherwise coalesce.

After time T_{HEAT_OFF} the build material on which no cooling agent was applied cools down back to the temperature TEMP_{PREHEAT}, during which time it solidifies. At the same time, the build material on which cooling agent was applied sees its temperature rise back to the temperature TEMP_{PREHEAT} (assuming that a preheating energy is re-applied).

As the temperature of the build material to which cooling agent was applied remains somewhat below the temperature TEMP_{MELT} this prevents build material on which cooling agent is applied from melting, sintering, fusing, or otherwise coalescing due to thermal bleed from a portion of build material which has reached, or has approached, the temperature TEMP_{MELT}.

In a further example, illustrated in FIG. 8, the pattern of cooling agent may be applied in a pattern that extends beyond the heating band boundaries by a predetermined amount, to provide a cooling agent buffer region 802. For example, the cooling agent buffer region may provide cooling agent to an additional region of build material beyond, where appropriate, the heating cell boundaries. In one example the cooling agent buffer region may be a region of about 1 mm in width, about 2 mm in width, about 5 mm in width, or about 10 mm in width.

In a further example, illustrated in FIG. 9, the pattern of cooling agent may be applied around the portion of build material to be solidified 508 in a pattern having at least the minimum predetermined width, but wherein the lateral extremities of the pattern of cooling agent, for each heating band, are aligned along the x-axis. In this way, each energy element 202 may be activated at the appropriate time, as the energy source 110 is moved over the build platform 502 to apply energy only to the portions of build material to be solidified, or to those portions on which cooling agent is applied.

In a further example, the fusing energy source 110 may be a static array of energy sources positioned above the build platform 102.

Although the examples described herein describe how a portion of build material to be solidified is surrounded by a region of build material on which cooling agent is applied, it should be understood that the effect of this cooling region may be achieved without completely surrounding a portion of build material with a cooling agent. For example, a cooling agent may be applied in a halftone pattern wherein a predetermined amount of cooling agent is distributed over a predetermined area of build material in a given drop density. In another example, cooling agent may be applied discontinuously, for example in pattern defining a small break in the pattern of cooling agent. This build material corresponding to the break may, however, be prevented from heating up sufficiently dues to the cooling effect of build material surrounding the break portion on which cooling agent is applied.

The examples described herein describe how the portion of build material that is to be solidified is surrounded by a region of build material on which cooling agent is applied. However, in some examples, the build material to be solidified may be surrounded in part by a region of build material on which cooling agent was applied, and in part by at least a portion of one or more of the outer walls of the build chamber 104. This may be the case, for example, if a portion of build material to be solidified is located at the edge of a layer of build material.

The example 3D printing systems and processes described herein may be able to generate 3D objects using thermal melting, fusing, sintering, or coalescing, using much less energy than other systems. Furthermore, use of only a single cooling agent that leaves substantially no residual traces on build material, enables high non-solidified build material reuse.

Furthermore, the surface of each formed layer of build material to which fusing energy is to be applied is, at least substantially, optically uniform. For example, there may be no significant optical, or energy absorption, difference between a portion of build material on which no cooling agent is applied and which is to be solidified and a portion of build material on which cooling agent is applied which is not to be solidified. In one example, the energy absorption characteristics of build material and build material on which cooling agent has been applied may within about 10%, or within about 5%, or within about 1%. This is due to the cooling agent being either transparent or having a colour that is closely matched to the colour of the build material. This is contrast to 3D printing systems that use a fusing energy absorbing fusing agent to define a portion of build material that is to be solidified. Such systems generally form successive layers of a white or light-coloured granular build material which generally reflects fusing energy, and selectively apply a fusing energy absorbing fusing energy to portions of each layer that are to be solidified, after application of fusing energy. In such systems layers of build material may exhibits considerable optical, or energy absorbance, differences between the white build material and portions of the build material on which fusing agent is applied. Such differences generally lead to reflection of energy from build material on which no fusing agent is applied which is reflected onto the energy source and may be re-reflected back onto the build material layer in a manner dependent on the patterns of fusing agent applied to each layer. Consequently, this may cause non-uniform heating of build material which may impact geometrical accuracy of generated 3D objects.

Additionally, in the examples described herein the portions of build material to be solidified do not have any agent applied thereto, compared to 3D printing systems that apply fusing agents to portions of build material to be solidified. It has been observed that the application of fusing agent to a portion of build material mechanically disturbs build material particles in the portion, as a result of fusing agent drops hitting the build material surface. This action may lead to generated 3D objects having a pitted or somewhat rough surface. In the examples described herein, however, there is no such disturbance of a portion of build material to be solidified, and consequently generated 3D objects may have a higher comparable smoothness or a generally higher quality surface finish.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program. Still further, some examples of the present invention may be conveyed electronically via any medium such as a communication signal carried over a wired or wireless connection.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

Example implementations can be realised according to the following clauses:

Clause 1. An additive manufacturing system comprising: a build material distributor to form a layer of build material on a build platform;
a cooling agent distributor to selectively distribute a cooling agent to a layer of build material;
an energy module to selectively apply energy to portions of a build material layer; and a controller to:
obtain data derived from a 3D object model relating to an object to be generated;
form a layer of the object by:
   controlling the cooling agent distributor, based on the obtained data, to print a pattern of cooling agent in a region surrounding a portion of build material to be solidified to form a layer of the object; and
   controlling the energy module to apply fusing energy only to build material on which cooling agent was applied and to the surrounded portion of build material such that the surrounded portion of build material heats up sufficiently to coalesce, and then solidify, and such that coalescence of build material on which cooling agent is applied is prevented, due to a cooling effect of the cooling agent, in response to being heated from any one of: the energy source; and thermal conduction from the surrounded portion.

Clause 2. The additive manufacturing system of clause 1, wherein the build material has a colour, and wherein the cooling agent is one of either: transparent; and a colour closely matching the colour of the build material.

Clause 3. The additive manufacturing system of claim 2, wherein there build material, and build material on which cooling agent has been applied have similar optical and/or energy absorption characteristics.

Clause 4. The additive manufacturing system of clause 1, 2, or 3, wherein the controller is to control the cooling agent distributor to apply the pattern of cooling agent in a cooling boundary region surrounding the portion of build material to be solidified, the pattern having a predetermined minimum width.

Clause 5. The additive manufacture system of clause 1, 2, 3, or 4, wherein the energy source comprises an array of individually controllable energy elements to each selectively apply energy to a heating cell within a respective heating band of a layer of build material.

Clause 6. The additive manufacturing system of clause 5, wherein the controller is to control the cooling agent distributor to apply the pattern of cooling agent to have an outer boundary that is aligned with the outer boundary of each of the heating cells in which the cooling boundary region of the cooling agent pattern is present.

Clause 7. The additive manufacturing system of any of clauses 1 to 6, wherein the controller is to control the cooling agent distributor to apply a quantity of cooling agent such that, after application of fusing energy, all, or substantially all, of the cooling agent evaporates.

Clause 8. The additive manufacturing system of any of clauses 1 to 7, wherein the controller is to control the cooling agent distributor to apply a quantity of cooling agent such that, after application fusing energy, a portion of the cooling agent remains.

Clause 9. The additive manufacturing system of any of clauses 1 to 8, wherein the application of cooling agent to build material causes at least one of: an immediate or quasi-immediate reduction in the temperature of build material to which it is applied; and a cooling effect subsequent to its application when fusing energy applied to build material on which cooling agent is applied.

Clause 10. A method of additive manufacturing comprising:

obtaining data relating to a 3D object to be manufactured;

forming a layer of build material on a build platform;

applying a cooling agent in a pattern surrounding a portion of build material to be solidified;

applying energy only to the build material on which cooling agent is applied and to the surrounded portion of build material such that the surrounded portion of build material heats up sufficiently to coalesces, and such that build material on which cooling agent is applied is cooled by the cooling agent and is prevented from heating up sufficiently to coalesce.

Clause 11. The method of clause 10, wherein applying the cooling agent comprises apply a quantity of cooling agent such that, after application of energy, the cooling agent substantially evaporates.

Clause 12. The method of clause 10 or 11, wherein applying the cooling agent comprises applying the cooling agent in a pattern having at least a predetermined width that surrounds the portion of build material to be solidified.

Clause 13. The method clause 10, 11, or 12, wherein applying the cooling agent comprises applying one of: a transparent cooling agent; and a cooling agent have a similar colour to the build material.

Clause 14. The method of any of clauses 10 to 13, wherein applying energy comprises selectively applying energy from an array of individually controllable energy sources each to apply energy to a layer of build material in a respective heating band, and wherein applying the pattern of cooling agent comprises applying the cooling agent in a pattern that is aligned with portions of each heating band.

Clause 15. An object generated by the additive manufacturing method of any of clauses 10 to 14.

1. An additive manufacturing system comprising:
a build material distributor to form a layer of build material on a build platform;
a cooling agent distributor to selectively distribute a cooling agent to a layer of build material;
an energy module to selectively apply energy to portions of a build material layer; and a controller to:
obtain data derived from a 3D object model relating to an object to be generated;
form a layer of the object by:
controlling the cooling agent distributor, based on the obtained data, to print a pattern of cooling agent in a region surrounding a portion of build material to be solidified to form a layer of the object; and
controlling the energy module to apply fusing energy only to build material on which cooling agent was applied and to the surrounded portion of build material such that the surrounded portion of build material heats up sufficiently to coalesce, and then solidify, and such that coalescence of build material on which cooling agent is applied is prevented, due to a cooling effect of the cooling agent, in response to being heated from any one of: the energy source; and thermal conduction from the surrounded portion.

2. The additive manufacturing system of claim 1, wherein the build material has a colour, and wherein the cooling agent is one of either: transparent; and a colour closely matching the colour of the build material.

3. The additive manufacturing system of claim 2, wherein there build material, and build material on which cooling agent has been applied have similar optical and/or energy absorption characteristics.

4. The additive manufacturing system of claim 1, wherein the controller is to control the cooling agent distributor to apply the pattern of cooling agent in a cooling boundary region surrounding the portion of build material to be solidified, the pattern having a predetermined minimum width.

5. The additive manufacture system of claim 1, wherein the energy source comprises an array of individually controllable energy elements to each selectively apply energy to a heating cell within a respective heating band of a layer of build material.

6. The additive manufacturing system of claim 5, wherein the controller is to control the cooling agent distributor to apply the pattern of cooling agent to have an outer boundary that is aligned with the outer boundary of each of the heating cells in which the cooling boundary region of the cooling agent pattern is present.

7. The additive manufacturing system of claim 1, wherein the controller is to control the cooling agent distributor to apply a quantity of cooling agent such that, after application of fusing energy, all, or substantially all, of the cooling agent evaporates.

8. The additive manufacturing system of claim 1, wherein the controller is to control the cooling agent distributor to apply a quantity of cooling agent such that, after application fusing energy, a portion of the cooling agent remains.

9. The additive manufacturing system of claim 1, wherein the application of cooling agent to build material causes at least one of: an immediate or quasi-immediate reduction in the temperature of build material to which it is applied; and a cooling effect subsequent to its application when fusing energy applied to build material on which cooling agent is applied.

10. A method of additive manufacturing comprising:
obtaining data relating to a 3D object to be manufactured;
forming a layer of build material on a build platform;
applying a cooling agent in a pattern surrounding a portion of build material to be solidified;
applying energy only to the build material on which cooling agent is applied and to the surrounded portion of build material such that the surrounded portion of build material heats up sufficiently to coalesces, and such that build material on which cooling agent is applied is cooled by the cooling agent and is prevented from heating up sufficiently to coalesce.

11. The method of claim 10, wherein applying the cooling agent comprises apply a quantity of cooling agent such that, after application of energy, the cooling agent substantially evaporates.

12. The method of claim 10, wherein applying the cooling agent comprises applying the cooling agent in a pattern having at least a predetermined width that surrounds the portion of build material to be solidified.

13. The method of claim 10, wherein applying the cooling agent comprises applying one of: a transparent cooling agent; and a cooling agent have a similar colour to the build material.

14. The method of claim 10, wherein applying energy comprises selectively applying energy from an array of individually controllable energy sources each to apply energy to a layer of build material in a respective heating band, and wherein applying the pattern of cooling agent comprises applying the cooling agent in a pattern that is aligned with portions of each heating band.

15. An object generated by the additive manufacturing method of claim 10.
